(19) United States
(12) Patent Application Publication
(10) Pub. No.: US 2009/0304469 A1
(43) Pub. Date: Dec. 10, 2009

(54) DRILL BIT ASSEMBLY FOR DRILLING OF LOCKS

(76) Inventors: Martin Jalove, Arlington Heights, IL (US); Harold Heidenreich, Schaumburg, IL (US)

Correspondence Address: SEYFARTH SHAW LLP, 131 S. DEARBORN ST., SUITE 2400, CHICAGO, IL, 60603-5803, US

(21) Appl. No.: 12/134,075

(22) Filed: Jun. 5, 2008

(51) Int. Cl. B23B 49/00

(52) U.S. Cl. 408/97

(57) ABSTRACT

An assembly for use with a power drill is provided for drilling of locks, the entire assembly being supportable by the drill. The assembly includes a bit and spindle that are advanceable to drill a lock, and includes a registration portion such as a key blank receivable in a key hole of the lock in order to provide the proper position and orientation of the drill for reaching the drill points of the lock. The assembly may includes a first subassembly secured with the drill chuck, and a plurality of second subassemblies mountable on the first subassembly, the second subassemblies having different configurations for different locks or lock types.

### FIELD OF THE INVENTION

The invention relates to drilling of locks and, in particular, to an assembly for attachment and use with a drill for drilling locks, and a method of using the assembly.

### BACKGROUND

It is well-known to drill locks when, for one reason or another, nobody is able to properly open the lock, such as with a key, by picking, or other manipulation. In simple terms and as an example, a common lock includes a number of tumblers. The tumblers are the moving parts which are typically shifted either by insertion of a key within the tumblers, via a key hole, or by rotational movement of the key within the tumblers and the lock itself.

There are two basic manners for drilling a lock, each designed to drill out a portion of the lock so the lock can be unlocked, or opened, or activated, or whatever the industry term is for the specific type of lock being drilled, collectively referred to herein for simplicity as ‘unlocked’ or ‘to unlock.’

In the first basic manner of drilling a lock, a person simply holds a power drill and attempts to align the bit with a proper entry point of the lock so that the drill bit can be driven into the lock to destroy or otherwise disable the tumblers or another part of the lock, thereby causing the lock to unlock. A few of the problems with this method are that the user, who may or may not be a locksmith, likely needs a bit that will cut metal and has to know where the critical to-be-drilled portion of the lock is, such as the tumblers, so that the bit can be aligned therewith. Perhaps the greatest issue with this method is that the bit tends to walk on the surface of the lock, thereby shifting alignment of the bit away from the intended line. Should the bit walk and begin to bite in an unintended region on the surface of the lock, the resulting hole or indentation is difficult to avoid when trying to reposition the bit in proper alignment.

In the second basic manner of drilling a lock, a template or drill guide is place over the lock, such as is described in U.S. Pat. No. 6,824,335, to Lynch. The drill guide includes a dummy or blank key portion secured with a body, the body including a throughbore for receiving a drill bit. The drill guide is positioned on the lock by inserting the blank key portion into the key hole. A drill bit is then fed into the throughbore that is, presumably, aligned with the proper drill point. This manner can be quite dangerous, as the spinning drill bit is within and may contact the throughbore. This contact can cause the drill guide to move and shift away from the proper drill point and can cause damage to both the bit and the guide. This damage itself may present a hazard to a user. It is also known that such movement often tempts users into manually holding the drill guide while operating the drill, which makes the user's hand vulnerable to injury. Once the hole is drilled, the bit must also be backed-out of the hole and the guide which may present its own problems if the hole is not straight or damage occurred between the guide and the bit.

Accordingly, there has been a need for an improved method and assembly for use with a drill for drilling of locks.

### SUMMARY

In accordance with an aspect, an assembly for drilling a lock is disclosed including a drill bit operatively connectable with a drill for receiving power from the drill, a guide portion rotatably supporting the drill bit, and a registration portion mountable with the lock, wherein the guide portion and the registration portion provide a predetermined drill point on or proximate to the lock for the drill bit.

In some forms, assembly includes a spindle having a first end connectable with a chuck on the drill, the drill bit being connectable with a second end of the spindle, the guide portion rotatably supporting the drill bit and spindle.

In some forms, the assembly includes a bias member for resiliently biasing the drill bit to a rearward position. The registration portion may be receivable within the lock. The registration portion may be a key blank corresponding to a particular lock.

In some forms, the assembly includes a first subassembly including the drill bit and the guide portion, and includes a second subassembly including the registration portion, wherein the first and second subassemblies are mountable with each other in at least a first predetermined configuration. The first and second subassemblies may be mountable with each other in at least a first predetermined configuration for a particular lock. The first and second subassemblies may be mountable with each other in at least a second predetermined configuration. The assembly may further include a plurality of second subassemblies, each having a registration portion corresponding to particular locks and each being selectively mountable with the first subassembly.

The first subassembly may include a feature for retaining the second subassembly thereon. The feature may include a magnet, and the second subassembly may include at least a ferrous portion attracted to the magnet.

In another aspect, a drill assembly for use with a drill bit in drilling a lock is disclosed including a spindle receivable in a drill chuck for receiving power from the drill, the spindle transmitting the power to drill bit, a guide housing rotatably supporting the spindle and drill bit, and a registration portion mountable with the lock so that the spindle is advanceable to force the drill bit into a drill point for the lock.

In some forms, a portion of the spindle and a portion of the guide housing may form a bearing surface to guide the spindle within guide housing along an axis of rotation aligned with the drill point.

In some forms, the registration portion is removably mountable with the guide housing. The registration portion may be mounted on a body, and the body may be used as a dummy key after drilling the lock.

In an additional aspect, in combination with a drill bit and a power drill, an assembly for drilling a lock is disclosed including a first subassembly having a spindle having a chuck tip securable with a chuck of the drill, having a bore for receiving and securing the drill bit therein, and having a bearing surface, a housing having a cylindrical portion in contact with and rotatably supporting the spindle bearing surface to guide longitudinal movement by the spindle along an axis of rotation thereof, and a first portion of registration structure, and including a second subassembly having a second portion of registration structure for mating with the first portion of registration structure of the first subassembly to provide a predetermined configuration for the first and second subassemblies, a registry portion for registration with a lock, a body for supporting the registry portion, wherein the first and second subassemblies are removably mountable with each other.

In some forms, the chuck tip is generally triangular.

In some forms, the combination includes a depth stop for determining an amount of forward advancement of the drill bit. The spindle may include graduated markings and a channel, the depth stop being securable along the channel in alignment with the graduated markings.

In some forms, the entire assembly is supportable by the drill.

### BRIEF DESCRIPTION OF THE DRAWINGS

FIG. 1 is a side perspective view of a lock-drilling assembly of the present invention showing a first subassembly securable with the chuck of drill at a first end of the lock-drilling assembly and showing a second subassembly receivable in a lock for providing a predetermined orientation of the lock-drilling assembly with the lock, the second subassembly being removably mounted on the first subassembly, the lock-drilling assembly being shown in a first position with a spindle of the first subassembly substantially retracted;

FIG. 2 is a front perspective view of the lock-drilling assembly of FIG. 1 showing the second subassembly removed from the first subassembly to expose a drill bit of the first subassembly, the first subassembly and second subassembly having cooperating registration structure for providing a predetermined orientation of the first subassembly with the second subassembly, the second subassembly having at least a first throughbore aligned with the drill bit to permit the drill bit to pass therethrough, the lock-drilling assembly being shown in the first position with the drill bit and the spindle substantially retracted;

FIG. 3 is a side perspective view of the lock-drilling assembly of FIG. 2 showing the lock-drilling assembly in a second position with the spindle and drill bit forwardly advanced for drilling a lock so that the drill bit extends from the throughbore of the second subassembly and a depth stop mounted on the spindle is in abutment with a housing of the first subassembly;

FIG. 4 is a first partially exploded view of the lock-drilling assembly of FIG. 1 showing the second subassembly separated from the first subassembly, and showing the depth stop and drill bit removed from the spindle;

FIG. 5 is a rear elevational view of the first subassembly showing a retainer maintaining the spindle within the housing;

FIG. 6 is an exploded view of a portion of the first subassembly showing the retainer and spindle removed from the housing, and showing a resilient bias member removed the housing, the resilient bias member being used to bias the spindle rearwardly against the retainer when the first subassembly is assembled;

FIG. 7 is a side elevational view of the spindle showing a channel for cooperating with the depth stop, graduated markings along the channel, and showing a set screw for securing the drill bit in bit port of the spindle, the bit port shown in phantom;

FIG. 8 is a rear elevational view of the spindle showing a configuration of a chuck end receivable in the drill for securing therewith, and showing in phantom the bit port and a threaded bore for the set screw;

FIG. 9 is a cross-sectional view of the depth stop showing a central bore in which the spindle is received and a threaded set screw receivable in the spindle channel of FIG. 7 for securing the depth stop with the spindle;

FIG. 10 is cross-sectional view of the housing showing a channel for receiving the retainer and showing a throughbore through which the drill bit is reciprocable, a portion of the registration structure extending from a front of the housing;

FIG. 11 is a front elevational view of the housing showing the throughbore, the registration structure, and showing a securement feature for retaining the second subassembly on the front of the housing, the securement feature in the present form being a magnet;

FIG. 12 is a perspective view of the second subassembly of FIG. 1 showing a second portion of the registration structure; and

FIGS. 13a-13c are perspective views of additional forms of second subassemblies mountable on the first subassembly for use in drilling a lock.

### DETAILED DESCRIPTION

Referring to the Figures, a lock-drilling assembly 10 for use with a drill (not shown) in order to drill a lock is depicted. In simplest terms, the lock-drilling assembly 10 is mounted with a drill and has a registry portion 12 mateable with a lock so that, upon forward pressure by a user, a drill bit 16 secured with and generally a part of the lock-drilling assembly 10 may be advanced forwardly to an extended position from the lock-drilling assembly 10 to drill the lock. The configuration of the lock-drilling assembly 10 and the registration portion 12 allows the drill bit 16 to drill at a proper drill point on the lock in order to unlock the lock.

It should be noted that the lock-drilling assembly 10 may be used with any type of lock, including cylinder locks, cam locks, switch locks, ignition locks, padlocks, bolting locks, latching locks, etc. It should further be noted that the bit 16 may be used to drill-out tumblers of the lock, as discussed above, or any other point that, when drilled-out, allows the lock to be unlocked, released, opened, or otherwise overcome the absence of a key, combination, or other intended means for operating the lock, or to allow the lock or a portion thereof to be removed so that which is maintained in a closed position (such as a safe, a box, or a door, e.g.) by the lock may be opened, collectively referred to as ‘unlock,’ ‘unlocking,’ or variants thereof. Accordingly, as used herein, the term drill point is a location on the face of the lock that is aligned with a point or points within the lock that, when drilled, unlock or disable the lock.

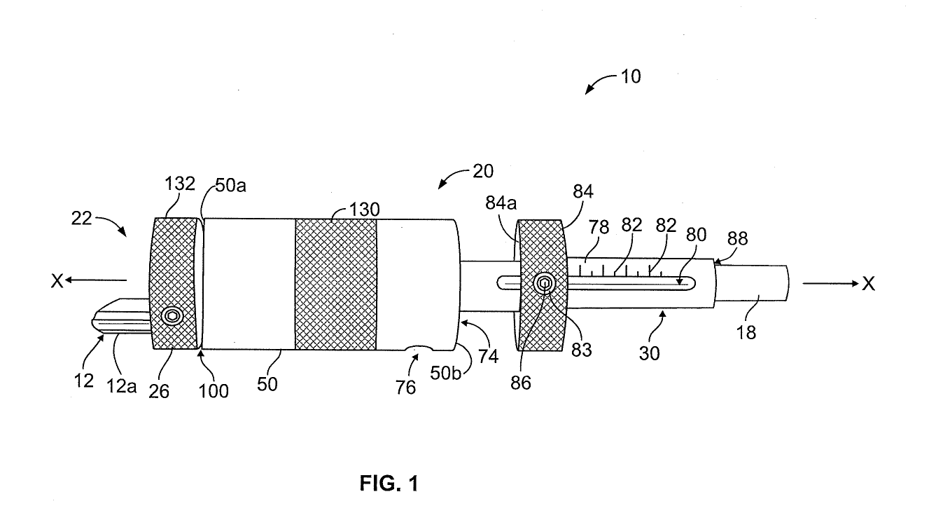

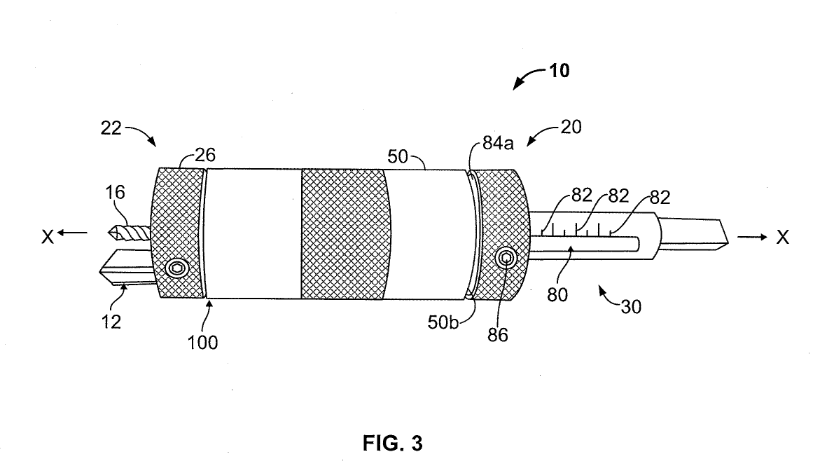

The lock-drilling assembly 10 in the present form includes a first subassembly 20 and a second subassembly 22. As will be described herein, the first subassembly 20 carries the drill bit 16 on a spindle 30, the spindle 30 being securable with a chuck of a drill (not shown), and the second subassembly 22 carries the registry portion 12 for mating with the lock. In use, the registry portion 12 is mated with the lock, and, with the drill activated to rotate the spindle 30 and drill bit 16, the spindle 30 and drill bit 16 are advanced relative to each of the lock and the second subassembly 22, as well as other portions of the first subassembly 20, so that the drill bit 16 is driven along an into the lock at the drill point. Accordingly, the spindle 30 and drill bit 16 have a first position shown in FIG. 1 with the drill bit 16 in a generally retracted position and at rest in such position, and the spindle 30 and drill bit 16 have a second position illustrated in FIG. 3 wherein the drill bit 16 has been advanced to a position extended from both the first and second subassemblies 20, 22.

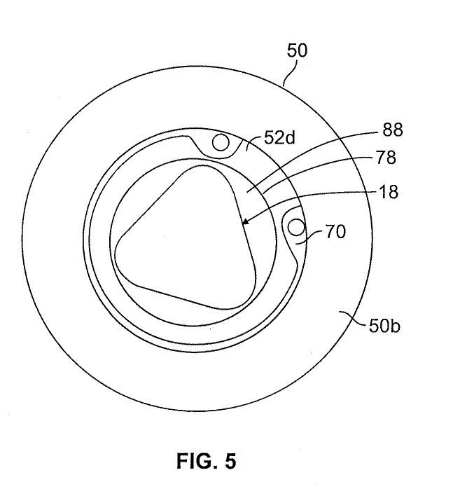

The spindle 30 includes a chuck tip 18 received in a drill chuck (keyed or keyless, e.g.). At times, the lock-drilling assembly 10 may be used with a combination of high-torque and high RPM in order to drill locks that may be made of a variety of materials including brass and hardened steel. At times, the torque forces received on the chuck tip 18 may be high in order to cut through the lock material. Therefore, the preferred form of the chuck tip 18 is a generally triangular cross-section, as can be seen in FIGS. 5 and 8, as is known in the field of power drill attachments.

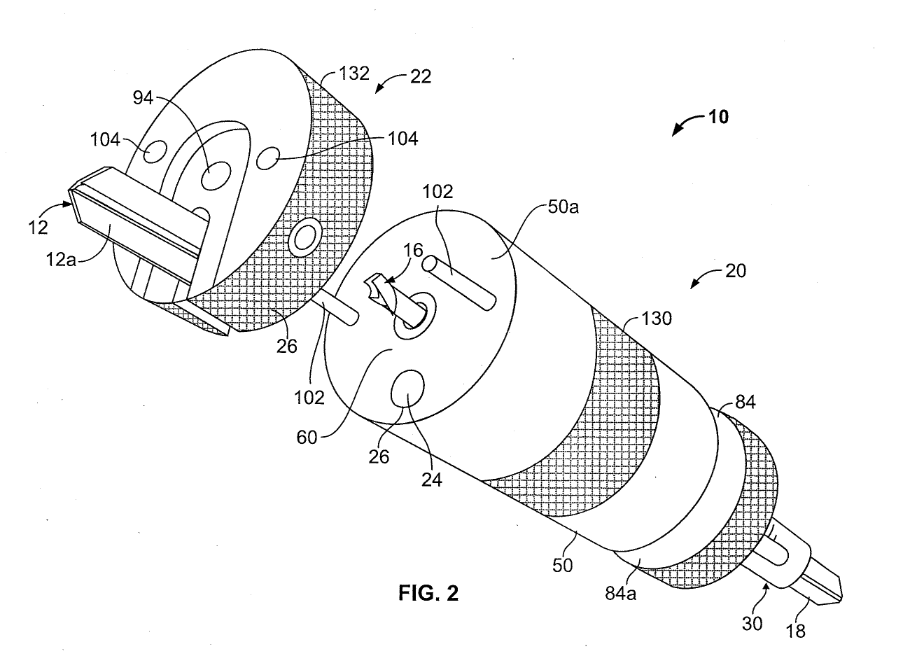

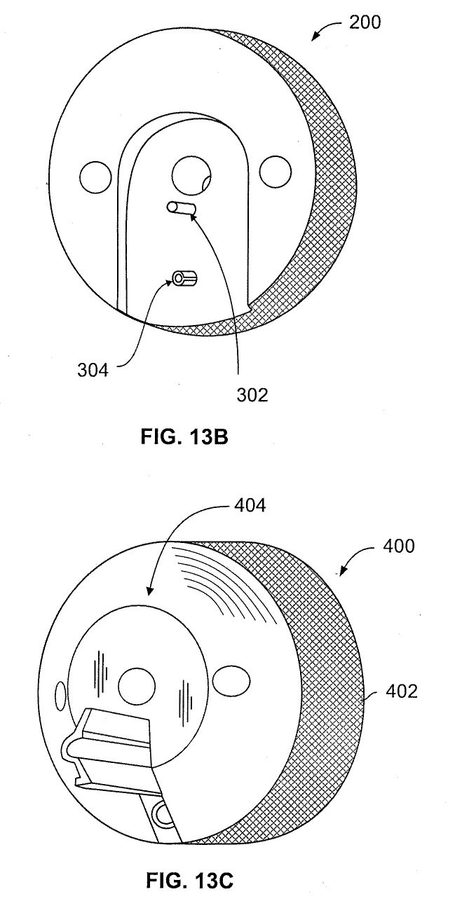

By comparing FIGS. 1 and 2, it can be seen that a preferred form of the lock-drilling assembly 10 allows the first and second subassemblies 20, 22 to be releasably or removably joined, though such is not required. In other words, the first subassembly 20 may be provided with a plurality of second subassemblies 22, each of the second subassemblies 22 being selectively removably joined with the first subassembly 20. FIGS. 13a-13c show alternative forms of the second subassembly 22. Accordingly, each of the second subassemblies 22 may be configured for a specific lock or lock-type.

In the present form, the second subassembly 22 is retained on the first subassembly 20 via a magnet 24 (see FIG. 2, e.g.). The first subassembly 20 includes a housing 50 that is formed of milled or machine ground billet aluminum. The housing 50 has a front face 50a with a counterbore 28, both oriented towards the second subassembly 22, and the magnet 24 is received and mounted within the counterbore 28. The second subassembly 22 includes a guide body 26 that is formed of a ferrous material (i.e., steel) so that the magnet 24 provides a retaining force to the guide body 26.

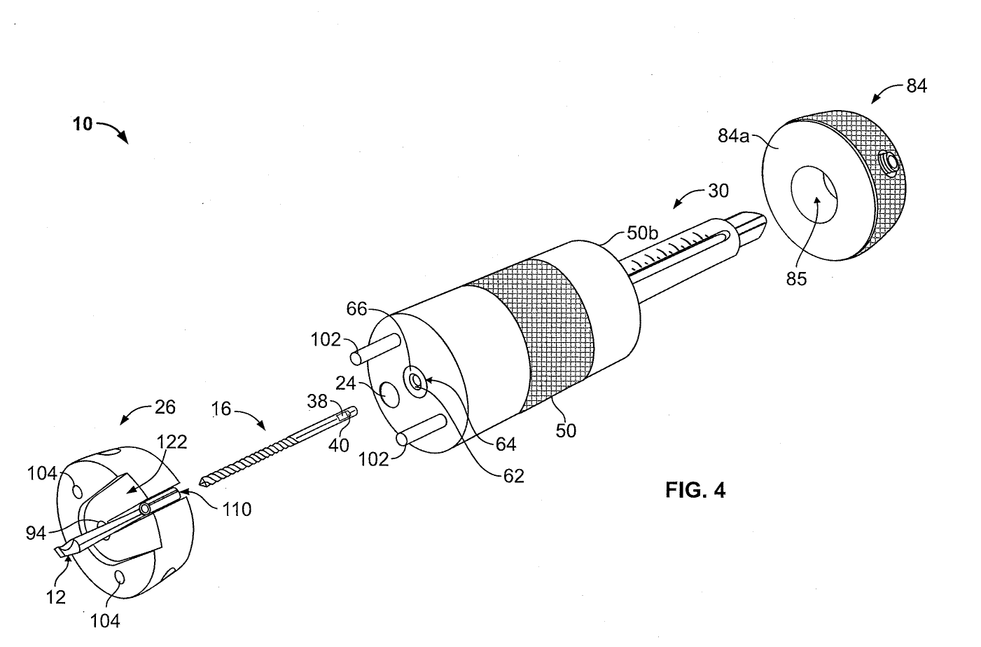

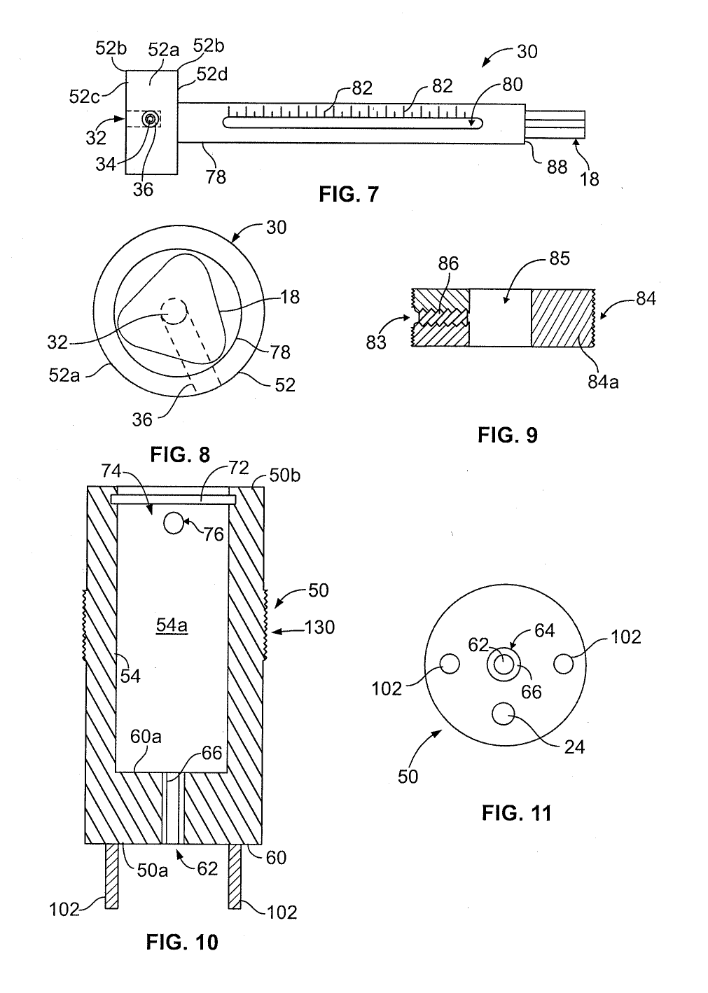

With reference to FIGS. 1 and 4-11, the first subassembly 20 includes the aforementioned drill bit 16 and spindle 30. In greater detail, the spindle 30 includes a bit bore 32, as can be seen in FIGS. 7 and 8, sized to permit the drill bit 16 to be slidingly inserted therein with minimal tolerance so that, when secured therein, the drill bit 16 and spindle 30 have a common central longitudinal axis, or axis of rotation X when powered by the drill, and both rotate without appreciable eccentricity, as is known and understood for drills and bits therefor.

To secure the drill bit 16 in the bit bore 32, the spindle 30 includes a threaded bore 36 for receiving a set screw 34, the threaded bore 36 intersecting with the bit bore 32 so that the set screw 34 is driven into and against the drill bit 16 in the bit bore 32. In a preferred form, the drill bit 16 has a flat 38 formed on a rearwardly portion 16a thereof, and the drill bit 16 is oriented within the bit bore 32 and relative to the threaded bore 36 so that the set screw 34 is driven against the flat 38. The engagement of the set screw 34 against the flat 38 resists rotation of the drill bit 16 relative to the spindle 30 due to, for instance, driving by the drill. The engagement allows a user a tactile indication of proper orientation and full receipt of the drill bit 16 within the spindle bit bore 32. Additionally, an abutment 40 is formed at a rear edge of the flat 38 which assists the bit 16 in resisting forces tending to pull the bit 16 out of the spindle bit bore 32.

The housing 50 functions to provide an alignment guide for the drill bit 16. Towards this end, the spindle 30 has a cylindrical and forward or distal portion referred to herein as the bearing portion 52 having a bearing surface 52a, and the housing 50 includes a central cylindrical surface 54 defining a cylindrical cavity 54a. Both the bearing surface 52a and cylindrical surface 54 are precision milled with minimal tolerances so they, together, are somewhat akin to a journal or sleeve bearing, though the interface therebetween is not generally subjected to significant loads. The bearing surface 52a and cylindrical surface 54 are shaped as such in order to define a path for the spindle 30 to move within the housing 50 along the axis X, whether the spindle 30 and bit 16 are rotating or not. Therefore, the cavity 54 is co-axial with the axis X. Preferably, lubrication is provide on the described interface, and edges 52b of the bearing surface 52a are radiused and de-burred.

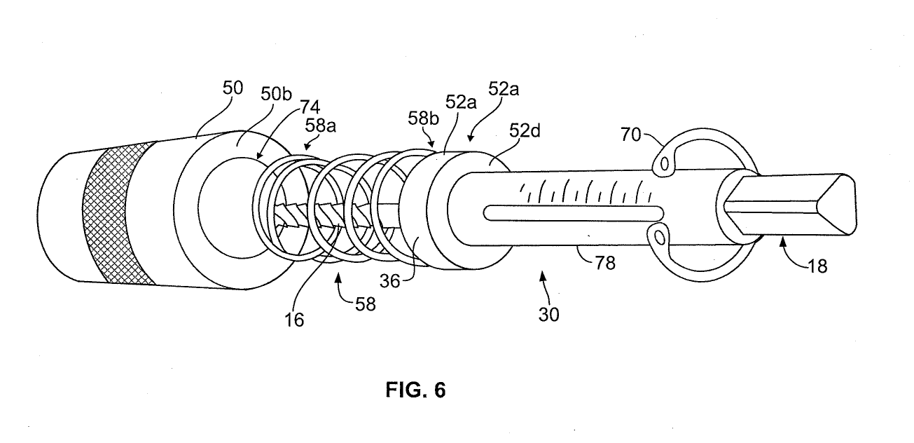

The spindle 30 with the bit 16 secured therewith are biased in a rearwardly direction so that, at rest, the bit 16 is in a generally retracted position, shown in FIG. 1. This allows the lock-drilling assembly 10 to have a starting or at rest position. The rearward bias is provided by a resiliently deformable bias member referred to herein as a spring and, in the present form, being a coil spring 58, as can best be seen in FIG. 6. As can be seen in FIG. 10, the housing 50 has a front wall 60 on which the front face 50a is formed. The front wall 60 has an interior surface serving to partially define the cylindrical cavity 54a and serving to form an abutment or shoulder 60a against which a first end 58a of the spring 58 contacts.

To provide rearward spring bias to the spindle 30 and bit 16, the spring 58 is positioned between the shoulder 60a and the spindle 30. More precisely, the spindle bearing portion 52 has a front face 52c (the bit bore 32 being formed in the front face 52c) against which a second end 58b of the spring 58 contacts. The bit 16 extends from the bit bore 32 with the spring 58 generally surrounding the bit 16. Forward advancement of the spindle 30 and bit 16 towards the front wall 60 compresses the spring 58, and releasing of the forward advancement force allows the spring 58 to force the spindle 30 and bit 16 towards the rearwardly, at-rest position.

The housing 50 is provided with a retainer 70 for holding the spindle 30 and within the housing 50 against the spring 58. As can be seen in FIGS. 5, 6, and 10, a channel 72 is provided on the cylindrical surface 54 and proximate an opening 74 in the rear of the housing 50. The retainer 70 in the form of a C-ring is compressed and received in the channel 72. Upon retraction of the spindle 30 to the first position, a rear face 52d of the bearing portion 52 contacts the retainer 70. With specific reference to FIG. 10, an access bore 76 is provided in the housing 50 so that the spindle set screw 34 can be reached to secure or release the bit 16 when the spindle 30 is in the retracted position. The spindle 30 also includes a stem portion 78 that generally extends from the housing 50 and though the retainer 70.

The spindle stem portion 78 also provides a stop or depth setting feature for the lock-drilling assembly 10. In the present form, the stem portion 78 includes a recessed channel 80 formed along the side of the stem portion 78 in a longitudinal direction, and graduated markings 82 are provided to the side of the channel 80. A depth stop in the form of an annular block 84 has a central passage 85 which is securable to and around the stem portion 78 via a set screw 86. The set screw 86 is advanced through a threaded bore 83 in the block 84 and into the channel 80. In comparing FIGS. 1 and 3, it can be seen that the block 84 permits forward advancement of the bit 16 and the spindle 30 to an extent that a front surface 84a of the block 84 contacts a rear surface 50b of the housing 50. Thus, the block 84 can be secured in a predetermined position to limit the depth of the bit 16 when drilled into a lock.

The spindle stem portion 78 and chuck tip 18 form a shoulder 88 that generally defines a maximum degree of insertion by the chuck tip 18 into a drill.

As described, the bit 16 is secured with the bit bore 32 of the spindle 30, and this point of securement is located within the housing 50 regardless of the position of the spindle 30 (i.e., forwardly advanced or in the at-rest, retracted position). In order to accommodate the bit 16 extending from the lock-drilling assembly 10 for drilling a lock, the housing front wall 60 includes a throughbore 62 from the cavity 54a to the exterior surroundings of the housing 50.

In a preferred form, the throughbore 62 is fashioned or adapted to help resist deflection of the bit 16 when being driven. As can be seen in FIG. 11, e.g., the housing 50 includes a mount bore 64, and an annular plug 66 including the throughbore 62 is mounted in the mount bore 64. The plug 66 and throughbore 62 can be selected for a bit 16 size (such as 5/16 diameter, as an example).

As noted above, the second subassembly 22 is removably secured on the first subassembly 20 and, specifically, against the front wall 60 of the housing 50. Accordingly, the second subassembly guide body 26 also permits and accommodates the bit 16 extending therethrough to reach the lock to be drilled. Towards this end, the guide body 26 includes a bit opening 94 concentrically aligned with the throughbore 62.

As noted above, the lock-drilling assembly 10 is designed to align the bit 16 with the proper drill point for a particular lock, and is designed to guide the bit 16 as the bit 16 is advanced against and into the lock. Accordingly, the lock-drilling assembly 10 is provided with the above-noted registration portion 12 carried on the second subassembly 22.

In order for the spindle 30 and bit 16 of the first subassembly 20 to be properly aligned relative to the registration portion 12 of the second subassembly 22, the subassemblies 20, 22 are also provided with registration structure 100. In the present form, the housing 50 includes a pair of registration pins 102 extending perpendicular from the front wall 60 and parallel to the longitudinal axis X. The guide body 26 includes a pair of registration pilots 104 (blind holes or throughbores, e.g.) properly spaced to receive the registration pins 102. When the second subassembly 22 is positioned on the first subassembly 20 (registration pins 102 received in the pilots 104), the guide body bit opening 94 is aligned with the housing throughbore 62 so that the bit 16 can pass through both.

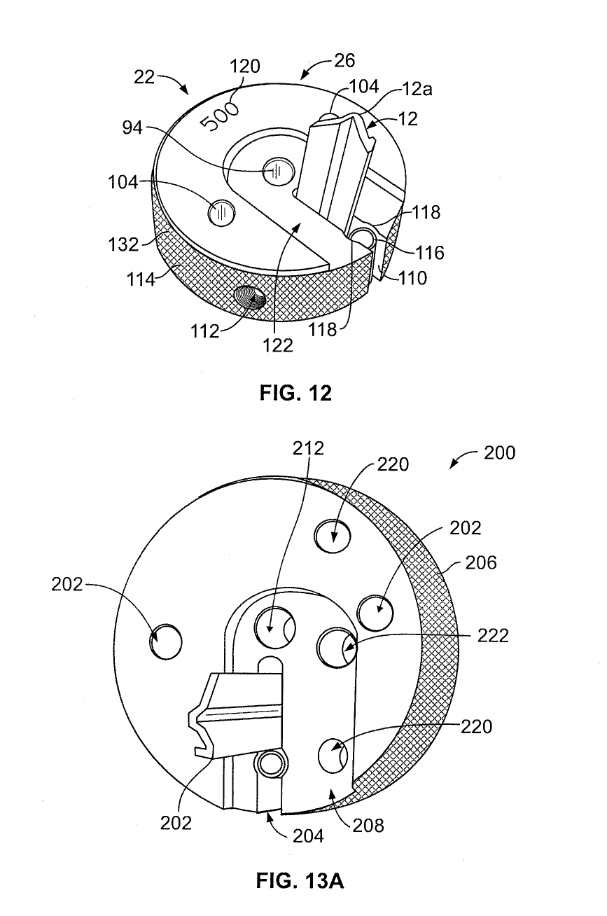

With the subassemblies 20, 22 mounted, the registration portion 12 mounts to or with the lock so that the proper drill point and alignment for the drill bit 16 are achieved. In the preferred and present forms disclosed herein, the registration portion 12 is in the form of a key blank. As can be seen in FIG. 12, the registration portion 12 is a first key blank 12a, while in the forms of FIGS. 13a-13c, alternative forms of a second subassembly are provided with alternative registration portions 12, each of which will be discussed below.

Turning to FIG. 12, the second subassembly 22 construction is shown. The key blank 12a is positioned in a radial cut 110 formed in the guide body 26. A set screw (not shown) is driven through a threaded bore 112 from a side 114 of the guide body 26 to mount the key blank 12a. A C-rod 116 is positioned in the radial cut 110 and, preferably, in slight cut-outs 118 in the guide body 26 formed along the radial cut 110. The C-rod 116 is forced into the cut-outs 118 so that it resists movement and, in particular, retards any pivoting tendency of the key blank 12a in the radial cut 110. Indicia 120 can be provided on the second subassembly 22 to designate its intended purpose. A carved out area 122 is provided around the registration portion in the form of the key blank 12a.

As can be seen, the registration pilots 104 extend completely through the guide body 26, as does the bit opening 94. The opening 94 and pilots 104 and the key blank 12a are configured relative to each other so that, with the first and second subassemblies 20,22 mounted with each other, and with the key blank 12a received in a key hole of the lock-to-be-drilled, the bit 16 under power is advanced from the retracted position (FIG. 1) to the extended position and into the drill point along the intended line for that particular lock so that the proper portions are drilled out.

During operation, the user would hold the drill with the lock-drilling assembly 10 mounted thereon. The registration portion 12 would be mounted with the lock, such as by inserting the key blank 12a into the lock keyhole. The user may then hold the housing 50, which includes exterior knurls 130, which may assist in steadying the assembly 10 and providing force to the bit 16.

In some uses, once the drilling is completed, the first and second subassemblies 20,22 may be separated with the second subassembly 22 remaining in registration with the lock, such as by having the key blank 12a remain inserted in the lock keyhole. The second subassembly 22 has knurls 132 on its periphery (i.e., side 114) and may be grasped and rotated so that it forms a dummy key.

Turning to FIGS. 13a-13c, alternative forms of the second subassembly are shown. FIG. 13a shows a second subassembly 200 having a registration portion 12 in the form of a key blank 202 secured in a radial cut 204 in a guide body 206. A carved out area 208 around the key blank 202 is offset from the radial cut, in comparison with the form of FIG. 12. The guide body 206 is provided with pilots 210 that are configured to be secured with the first subassembly registration pins 102 so that the bit 16 passes through a bit opening 212. Additionally, the guide body 206 is provided with a second pair of pilots 220 so that the second subassembly 200 may be mounted with the registration pins 102 in a different orientation, a second bit opening 222 being provided for the bit 16 to pass.

There are two different manners in which the form of the second subassembly 200 may be viewed. In one, the second subassembly 200 may be viewed as usable with more than one type of lock. In the other, the second subassembly 200 may be viewed as usable with a single lock type that has more than one drill point so that more than one drilling action is required to unlock the lock. In the latter, the second subassembly 200 would first be mounted with a first of the pilots (i.e., either 210 or 220) with the first subassembly 20 during a first drilling; then, the first subassembly 20 would be separated therefrom and remounted with the second of the pilots 220, 210.

FIG. 13b shows a form of a second subassembly 300 in which a pin 302 and a C-rod 304 are provided as the registration portion 12.

FIG. 13c shows a form of a second subassembly 400 in which a guide body 402 is provided for reaching a recessed lock area. Therefore, the guide body 402 includes a frustoconical raised portion 404.

It should be noted that the registration portion 12 may be generic or specific to a particular lock or type of lock. For instance, one of the key blanks such as 12a or 202 may be a key blank that fits a particular make/model of lock, a particular type of lock, or may be generic to any type of keyed locks or to a range of types of keyed locks. Additionally, the pin 302 may be viewed as a generic registration portion 12.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. An assembly for drilling a lock comprising:
a drill bit operatively connectable with a drill for receiving power from the drill;
a guide portion rotatably supporting the drill bit; and
a registration portion mountable with the lock, wherein the guide portion and the registration portion provide a predetermined drill point on or proximate to the lock for the drill bit.

2. The assembly of claim 1 including a spindle having a first end connectable with a chuck on the drill, the drill bit being connectable with a second end of the spindle, the guide portion rotatably supporting the drill bit and spindle.

3. The assembly of claim 1 including a bias member for resiliently biasing the drill bit to a rearward position.

4. The assembly of claim 1 wherein the registration portion is receivable within the lock.

5. The assembly of claim 4 wherein the registration portion is a key blank corresponding to a particular lock.

6. The assembly of claim 1 including:
a first subassembly including the drill bit and the guide portion; and
a second subassembly including the registration portion, wherein the first and second subassemblies are mountable with each other in at least a first predetermined configuration.

7. The assembly of claim 6 wherein the first and second subassemblies are mountable with each other in at least a first predetermined configuration for a particular lock.

8. The assembly of claim 7 wherein the first and second subassemblies are mountable with each other in at least a second predetermined configuration.

9. The assembly of claim 6 further including a plurality of second subassemblies, each having a registration portion corresponding to particular locks and each being selectively mountable with the first subassembly.

10. The assembly of claim 6 wherein the first subassembly includes a feature for retaining the second subassembly thereon.

11. The assembly of claim 10 wherein the feature includes a magnet, and the second subassembly includes at least a ferrous portion attracted to the magnet.

12. A drill assembly for use with a drill bit in drilling a lock, the assembly comprising:
a spindle receivable in a drill chuck for receiving power from the drill, the spindle transmitting the power to drill bit;
a guide housing rotatably supporting the spindle and drill bit; and
a registration portion mountable with the lock so that the spindle is advanceable to force the drill bit into a drill point for the lock.

13. The assembly of claim 12 wherein a portion of the spindle and a portion of the guide housing form a bearing surface to guide the spindle within guide housing along an axis of rotation aligned with the drill point.

14. The assembly of claim 12 wherein the registration portion is removably mountable with the guide housing.

15. The assembly of claim 14 wherein the registration portion is mounted on a body, and the body is usable as a dummy key after drilling the lock.

16. In combination with a drill bit and a power drill, an assembly for drilling a lock, the assembly comprising:
a first subassembly including:
a spindle having a chuck tip securable with a chuck of the drill, having a bore for receiving and securing the drill bit therein, and having a bearing surface;
a housing having a cylindrical portion in contact with and rotatably supporting the spindle bearing surface to guide longitudinal movement by the spindle along an axis of rotation thereof,
a first portion of registration structure; and
a second subassembly including;
a second portion of registration structure for mating with the first portion of registration structure of the first subassembly to provide a predetermined configuration for the first and second subassemblies,
a registry portion for registration with a lock;
a body for supporting the registry portion,
wherein the first and second subassemblies are removably mountable with each other.

17. The combination of claim 16 wherein the chuck tip is generally triangular.

18. The combination of claim 16 further including a depth stop for determining an amount of forward advancement of the drill bit.

19. The combination of claim 18 wherein the spindle includes graduated markings and a channel, the depth stop being securable along the channel in alignment with the graduated markings.

20. The combination of claim 16 wherein the entire assembly is supportable by the drill.
